(19) United States
(12) Patent Application Publication
(10) Pub. No.: US 2013/0136013 A1
(43) Pub. Date: May 30, 2013

(54) Handshaking Protocol Using Bursts in OFDMA Frame Structure

(71) Applicants: Jarkko Lauri Sakari Kneckt, Espoo (FI); Cássio Barboza Ribeiro, Espoo (FI); Michal Cierny, Helsinki (FI)

(72) Inventors: Jarkko Lauri Sakari Kneckt, Espoo (FI); Cássio Barboza Ribeiro, Espoo (FI); Michal Cierny, Helsinki (FI)

(73) Assignee: NOKIA CORPORATION, Espoo (FI)

(21) Appl. No.: 13/637,009

(22) PCT Filed: Mar. 29, 2010
(86) PCT No.: PCT/IB2010/000709

§ 371 Date: Dec. 3, 2012

(51) Int. Cl. H04W 72/08

(52) U.S. Cl. CPC H04W 72/082
USPC 370/252; 370/330

(57) ABSTRACT

One embodiment is directed to a method, apparatus, and/or computer program for reducing interference in a local area radio system. The method may include selecting, by a first network node, time/frequency resources to transmit data, transmitting request to send (RTS) bursts to a second network node on the selected resources, and listening for clear to send (CTS) bursts. The method may further include separating received clear to send bursts, decoding the clear to send bursts received from the second network node, determining whether data is allowed to be transmitted based on the received clear to send bursts, and transmitting the data to the second network node when it is determined that the data can be transmitted. The request to send and/or clear to send bursts may be encoded with orthogonal codes when there are multiple cells in a neighborhood of the first network node and/or the second network node.

### BACKGROUND

1. Field of Invention

Embodiments of the invention relate to communications networks and, particularly, to wireless communications networks. More specifically, certain embodiments of the invention are directed to methods, systems, apparatuses and computer programs for reducing interference in a local area radio system.

2. Description of Related Art

IEEE 802.11 is an example of a set of standards for carrying out wireless local area network (WLAN) computer communication in the 2.4, 3.6 and 5 GHz frequency bands. The 802.11 has grown to be a family of standards including over-the-air modulation techniques that may use the Medium Access Protocol (MAC) as defined for 802.11. The 802.11a standard defines an orthogonal frequency division multiplexing (OFDM) based air interface (physical layer). It operates in the 5 GHz band with a maximum data rate over air interface of 54 Mbit/s. The first widely accepted techniques, however, were those defined by the 802.11b and 802.11g protocols. 802.11b has a maximum air interface data rate of 11 Mbit/s and uses the same media access method defined in the original standard. 802.11b devices may suffer interference from other products operating in the 2.4 GHz band. 802.11g works in the 2.4 GHz band, like 802.11b, but uses the same OFDM based transmission scheme as 802.11a.

It operates at a maximum physical layer bit rate of 54 Mbit/s exclusive of forward error correction codes. 802.11n is a multi-streaming modulation technique, while other standards in the family (c-f, h, j) are amendments to medium access control, define measurements, network management extensions or define corrections to the previous specifications.

802.11b and 802.11g use the 2.4 GHz industrial scientific and medical (ISM) band in the United States. Because of this choice of frequency band, 802.11b and g equipment may occasionally suffer interference from microwave ovens, cordless telephones and Bluetooth devices. Both 802.11 and Bluetooth control their interference and susceptibility to interference by using spread spectrum modulation. Bluetooth uses a frequency hopping spread spectrum signaling method (FHSS), while 802.11b and 802.11g use the direct sequence spread spectrum signaling (DSSS) and OFDM methods, respectively. 802.11a uses the 5 GHz U-NII band which, for much of the world, offers at least 19 non-overlapping channels rather than the 3 offered in the 2.4 GHz ISM frequency band.

RTS/CTS (Request to Send/Clear to Send) is an optional mechanism used by the 802.11 wireless networking protocol to reduce frame collisions introduced by the hidden terminal problem. In the hidden terminal problem, the hidden terminal is not able to detect transmission from the transmitter and starts to transmit simultaneously, i.e. its Clear Channel Assessment (CCA) does not indicate transmission in the media and it starts to transmit when it obtains the transmission opportunity (TXOP). According the RTS/CTS mechanism, a node wishing to send data initiates the process by sending a Request to Send frame (RTS). The destination node replies with a Clear To Send frame (CTS). Any other node receiving the RTS or CTS frame should refrain from sending data for a given time. The RTS and CTS in 802.11 uses small frames to provide a duration value that is applied to set the Network Allocation Vector (NAV) protection for ongoing transmissions and avoiding transmissions from hidden terminals that may corrupt the ongoing transmissions. The RTS/CTS signaling, however, just generates overhead when the protected frames are in near equal size or if no hidden terminals exists.

### SUMMARY

In one embodiment, a method for reducing interference is provided. The method includes selecting, by a first network node, time/frequency resources to transmit data, transmitting first bursts to a second network node on the selected resources, and listening for all second bursts.

The method may further include separating received second bursts using orthogonal codes when the received second bursts are transmitted from different cells, decoding the second bursts received from the second network node, determining whether data is allowed to be transmitted based on the received second bursts, and transmitting the data to the second network node when it is determined that the data can be transmitted.

According to another embodiment, an apparatus, such as a network node, is provided. The apparatus includes at least one processor, and at least one memory including computer program code. The at least one memory and the computer program code are configured, with the at least one processor, to cause the apparatus at least to select time/frequency resources to transmit data, transmit first bursts to a network node on the selected resources, and listen for all second bursts. The apparatus may be further controlled, by the memory and processor, to separate received second bursts using orthogonal codes when the received second bursts are transmitted from different cells, decode the second bursts received from the network node, determine whether data is allowed to be transmitted based on the received second bursts, and transmit the data to the network node when it is determined that the data can be transmitted.

Another embodiment includes a computer program, embodied on a computer readable medium, the computer program configured to control a processor to perform operations. The operations include selecting, by a first network node, time/frequency resources to transmit data, transmitting first bursts to a second network node on the selected resources, listening for all second bursts, separating received second bursts using orthogonal codes when the received second bursts are transmitted from different cells, decoding the second bursts received from the second network node, determining whether data is allowed to be transmitted based on the received second bursts, and transmitting the data to the second network node when it is determined that the data can be transmitted.

In one embodiment, another method for reducing interference is provided. The method may include listening for all first bursts, separating received first bursts using orthogonal codes when the first bursts are transmitted from different cells, estimating future interference by measuring a power level of the received first bursts and comparing the measured power level to at least one criterion, and when the at least one criterion is met, sending a second burst to a first network node.

According to another embodiment, an apparatus, such as a network node, is provided. The apparatus may include at least one processor, and at least one memory including computer program code. The at least one memory and the computer program code configured, with the at least one processor, to cause the apparatus at least to listen for all first bursts, separate received first bursts using orthogonal codes when the first bursts are transmitted from different cells, estimate future interference by measuring a power level of the received first bursts and comparing the measured power level to at least one criterion, and, when the at least one criterion is met, send a second burst to a first network node.

Another embodiment is directed to a computer program, embodied on a computer readable medium, the computer program configured to control a processor to perform operations. The operations may include listening for all first bursts, separating received first bursts using orthogonal codes when the first bursts are transmitted from different cells, estimating future interference by measuring a power level of the received first bursts and comparing the measured power level to at least one criterion, and, when the at least one criterion is met, sending a second burst to a first network node.

### BRIEF DESCRIPTION OF THE DRAWINGS

For proper understanding of the invention, reference should be made to the accompanying drawings, wherein:

FIG. 1 illustrates a system according to one embodiment;

FIG. 2 illustrates a frame structure in accordance with one embodiment;

FIG. 3 illustrates a frame structure according to another embodiment;

FIG. 4 illustrates a signaling diagram according to one embodiment;

FIG. 5 illustrates a flow diagram of a method according to an embodiment;

FIG. 6 illustrates an apparatus according to one embodiment;

FIG. 7 illustrates a flow diagram of a method according to an embodiment;

FIG. 8 illustrates a flow diagram of a method according to another embodiment;

FIG. 9 is a graph illustrating the performance of certain systems according to an embodiment; and

FIG. 10 illustrates an example of the hard medium use rules, according to one embodiment.

### DETAILED DESCRIPTION

Embodiments of the invention are directed to a local area radio system, such as Local Area Evolution (LAE), to complement existing cellular wide area systems, such as the Global System for Mobile communications (GSM), the Universal Mobile Telecommunications System (UMTS), High Speed Packet Access (HSPA), and Long Term Evolution (LTE). Unlike these wide area cellular systems, the local area system can utilize the license-exempt spectrum or white spaces to take advantage of the additional available bandwidth. In addition, the local area system can offer an efficient device-to-device operation mode to establish ad-hoc networks.

In contrast to classical cellular networks with sophisticated base stations (BSs) and careful frequency planning, LAE networks aim for less sophisticated and inexpensive access points (APs), as well as uncoordinated deployment. Lower cost targets in connection with a possibility that, in some cases, a terminal with limited hardware/software resources may have to serve as an AP bring into consideration the concept of decentralized medium access control (MAC).

The uncoordinated deployment of LAE networks means that there is a need for efficient interference management within the network. Currently, home wireless networks are mostly based on IEEE 802.11 family of standards, which is optimized for a situation with a single AP. It has three orthogonal channels available at 2.4 GHz ISM-band; however, three channels are not sufficient in buildings with many rooms, apartments, and/or offices and, therefore, these deployments may have many interfering networks.

Thus, according to one embodiment of the invention, control bursts signaling, such as RTS/CTS from 802.11, is applied to an Orthogonal Frequency-Division Multiple Access (OFDMA) frame structure typical for current cellular networks. These control bursts provide a way to initialize transmission in a decentralized way and also enable the system to define a protected area around active receivers, which significantly reduces interference.

OFDM, as mentioned above, refers to a frequency-division multiplexing (FDM) scheme that is utilized as a digital multi-carrier modulation method. A large number of closely-spaced orthogonal sub-carriers are used to carry data. The data is divided into several parallel data streams or channels, one for each sub-carrier. Each sub-carrier is modulated with a conventional modulation scheme (such as quadrature amplitude modulation or phase-shift keying) at a low symbol rate, maintaining total data rates similar to conventional single-carrier modulation schemes in the same bandwidth. Orthogonal Frequency-Division Multiple Access (OFDMA) is a multi-user version of OFDM digital modulation scheme. Multiple access is achieved in OFDMA by assigning subsets of subcarriers to individual users.

The LAE radio system is seen as an example of an evolution to the 3GPP physical layer, and, therefore, is based on OFDM modulation. In this case, OFDMA transmissions are done in both the downlink and uplink directions. At the same time, LAE radio should provide reasonable inter-cell interference management capabilities in order to facilitate uncoordinated deployment of access points. Thus, one embodiment of the invention introduces a handshaking protocol with RTS/CTS signaling that is compatible with the OFDMA frame structure. These RTS/CTS control bursts can be used as a way to inform the surrounding nodes of transmission(s) and to set the interference limits to protect the negotiated transmission(s). Certain embodiments of the invention define the basic mechanism to measure the level of interference that the proposed transmission(s) will generate and limit the interference to below a predefined maximum interference level.

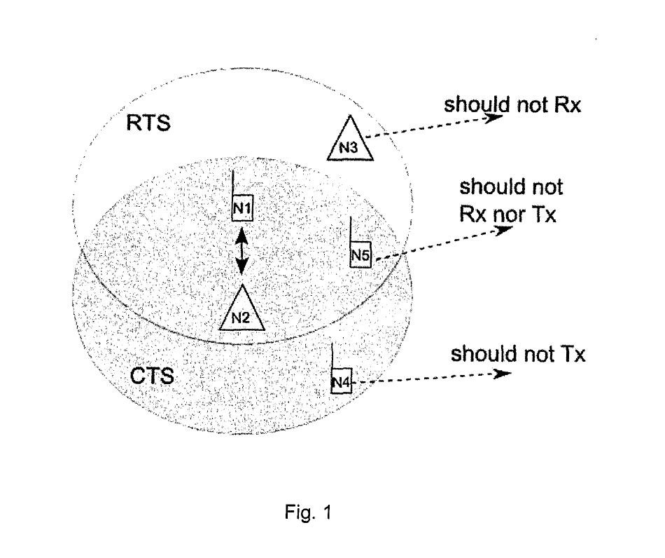

FIG. 1 illustrates a network with a plurality of network nodes N1-N5. The network nodes N1-N5 may be access points and/or terminals. Additionally, FIG. 1 shows a transmission area for a RTS burst sent from N1 to N2, and a transmission area for a responsive CTS burst sent from N2 to N1. In the example illustrated in FIG. 1, the node close to a RTS burst will be interfered with when receiving a signal; the node close to a CTS burst will cause interference with its own transmission; and the node close to both a RTS burst and a CTS burst will cause interference if it transmits and will be interfered with if it is receiving a signal.

According to the example of FIG. 1, certain rules are applied in an effort to prevent interference. In particular, the rules provide that: N3 hears the RTS and therefore should not be receiving; N4 hears the CTS and should not be transmitting; and N5 hears both the RTS and CTS and therefore should not transmit or receive. In some instances, however, these rules may be too rigid and not always applicable. Therefore, embodiments of the invention may apply the rules differently to provide an improved and flexible method for significantly reducing interference around network nodes, such as active receivers.

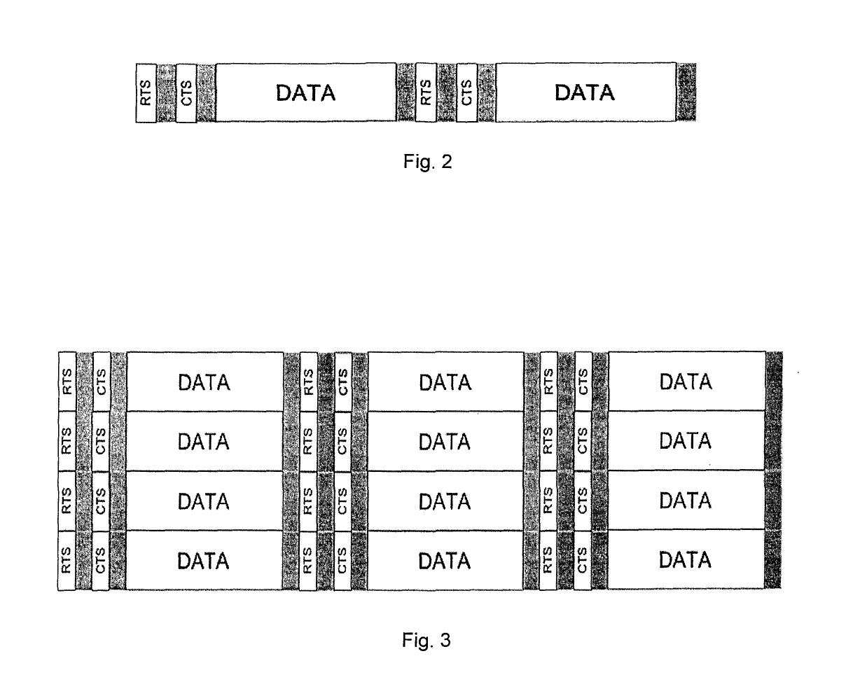

Reserving OFDMA symbols for RTS/CTS bursts and switching bursts between transmission and reception can create overhead. As such, it may be desirable to have only one RTS burst and one CTS burst per transmission frame. An example of such an arrangement is illustrated in FIG. 2. It is assumed that all nodes are synchronized in cyclic prefix level. FIG. 2 shows a frame structure with RTS and CTS bursts at specific time instances. The grey areas of FIG. 2 represent switching times between transmission and reception.

However, two inherent issues may arise with such an approach. First, the possibility for sending a RTS request is limited to very specific time/frequency instances, which is in contrast with the 802.11 free-running time base. As a result, it removes the option of spreading requests in time and rapidly increases the probability of collision. In order to address this issue, the nodes should be able to place their requests into given time/frequency instances without causing unnecessary collisions. Similarly, the 802.11 rapid recovery from the collision of simultaneous RTS transmissions is no longer applicable. A second issue is that a very strict use of RTS and CTS bursts may lead to medium waste. If a node is far away is from the control burst source but decodes it anyway, it should not be restrained from transmitting or receiving. Therefore, according to one embodiment, the rules for defining a protected area around the receiver are made more flexible thereby addressing at least these issues.

In one embodiment, the RTS/CTS exchange is used like a measurement to detect the interference levels of the multiple reservations, and to make reservations and allow reuse and better resource utilization, i.e., multiple transmissions to the same spectrum at a time.

More specifically, embodiments of the invention provide a twofold enhancement to an access protocol with a frame structure as shown in FIG. 2. In one embodiment, the RTS and CTS bursts sent by nodes belonging to different cells are separated by means of orthogonal codes.

This is done, for example, by using cell-specific subset of subcarriers in OFDMA transmission, or by utilizing orthogonal block codes. In another embodiment, an operation flow for reserving resources through RTS/CTS signaling is provided. The reception powers of RTS and CTS bursts are measured and these measurements are used to predict interference levels. Thresholds of acceptable interference and policy for accepting the reservations can be predefined at the MAC layer, configured by higher layer signaling, configured in a distributed manner between network nodes when a suitable interface exists, or defined independently by each network node. Embodiments of the invention allow for customization and configurable operation of these thresholds and policy.

By introducing the orthogonality, the RTS and CTS bursts originating from different cells are not colliding as easily and less transmission opportunities are lost. Compared to a configuration with no orthogonality, the signal to interference plus noise ratio (SINR) level needed for decoding a burst can decrease considerably.

This approach also provides new options for interference management. For example, if a receiver receives RTS bursts from several sources, it can measure their power and thus predict the total level of interference that it would be suffering. On the other hand, if a transmitter receives CTS bursts from different sources, it can predict, via the reciprocity principle, how much interference it would cause to the nodes that have sent them. By not accepting interference above a certain threshold, the system creates protected areas around the receivers.

For the purposes of this disclosure, a cell is defined as a set of Tx-Rx nodes that are primarily configured to communicate with each other. The concept includes the traditional cell of cellular communications, as well as an Access Point (AP) with the clients it serves, or potential device-to-device communication pairs, or clusters in ad-hoc networks, etc.

In one embodiment, the radio resource is divided into OFDMA frame structure as illustrated in FIG. 3. In the frequency domain, there are one or more sub-bands, and, in time, the transmissions are organized into fixed length frames. In particular, FIG. 3 illustrates an OFDMA frame structure with specific time/frequency spaces for RTS and CTS bursts. In the vertical direction, the resources are divided into frequency sub-bands, and in the horizontal direction the resources are divided into frames. According to an embodiment, all participating nodes are synchronized in a cyclic prefix sense. The direction of transmission (downlink—AP to client, or uplink—client to AP) does not have to be the same for different cells.

According to certain embodiments, when a transmitter wants to send data to a receiver, the transmitter places a RTS burst in one or more designated places. More details on this handshake process are discussed below. For downlink, this can be scheduled as in current cellular systems. In uplink, it can be resolved by contention among users as well as scheduling. Certain embodiments utilize orthogonality to act as an inter-cell interference management and limitation tool, while it may also resolve intra-cell collisions by properly defining the contention rules.

According to an embodiment, each data resource is negotiated independently through its own RTS/CTS signaling. If there are multiple RTS requests for a single data transmission resource, the transmitter resolution procedure solves the transmitter(s) for the data resource.

In one embodiment, the minimum information that both RTS and CTS bursts can carry includes: the MAC address/ID of the source node, the MAC address/ID of the destination node, the frequency slots of the reservation and the end time of the reservation, the indication as to whether the reservation is already accepted and the random access parameters. The random access parameters may include quality of service (QoS) or priority information. The random access parameters may improve efficiency and/or fairness, but may not always be included with the RTS and CTS bursts. The CTS message may also contain an indication of the success of the reservation, such as whether the reservation accepted and/or if the reservation is accepted with limitations.

The RTS and CTS bursts that originated from different cells are separated by means of orthogonal codes. In OFDMA, this is possible, for example, by distributing the information to different subsets of subcarriers. This is the same principle as in a normal OFDMA system, where multiple users inside a cell are assigned a different subset. The subset can be, for instance, localized (subcarriers of a subset are next to each other) or distributed (a subset consists of every Nth subcarrier). Another option is to assign the cells to the same subcarriers and use orthogonal codes, in the same manner as spreading codes in WCDMA or Zadoff-Chu sequences in the uplink of long term evolution (LTE).

Certain embodiments of the invention provide a clear way to assign codes for different cells in order to avoid situations where neighboring cells use the same codes thereby resulting in collisions. The selection can be organized, for example, by using one of the following options: (1) the codes are chosen and distributed by a central entity (e.g. a support node, server etc.); (2) the APs choose the codes for themselves and inform each other via AP-to-AP interface (e.g. X2) so that collisions are avoided; (3) the codes are chosen based on measurements (e.g. an AP can measure what codes are used in its vicinity and select a different one); and/or (4) codes can be chosen randomly within a pre-defined set.

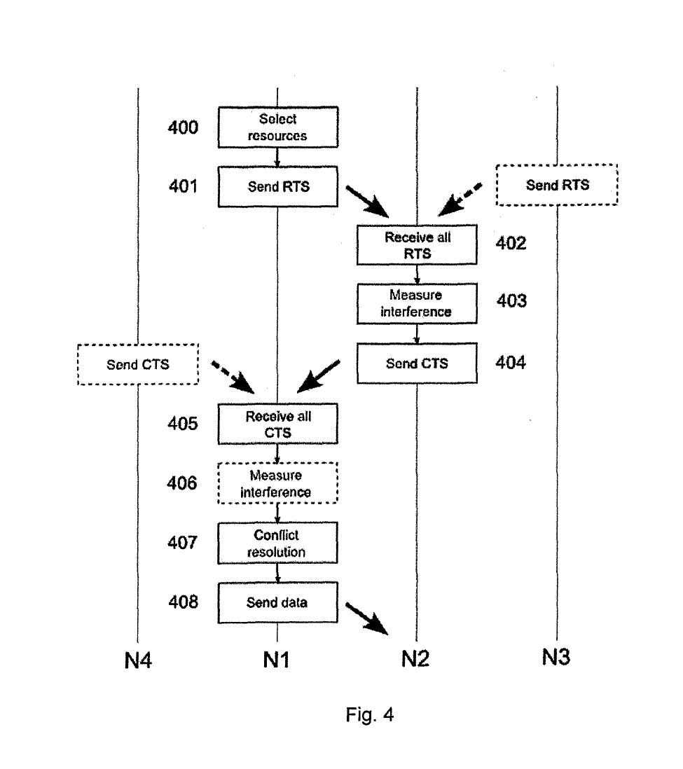

FIG. 4 illustrates an example of a signaling diagram for the handshaking protocol with orthogonal control bursts, according to one embodiment. FIG. 4 illustrates four nodes: node N1, which wants to transmit to node N2, a neighboring transmitter node N3, and a neighboring receiver node N4. At 400, node N1 chooses the time/frequency resources where it wants to transmit data. At 401, node N1 transmits RTS bursts addressed to N2 on the chosen resources. This transmission follows the principle explained above where a spreading code is chosen according to the cell that N1 is assigned to. The RTS burst is transmitted at the same transmission power that is applied for the data.

At 402, which corresponds to the RTS shown in FIG. 2, node N2 is in reception mode and tries to listen to all RTS bursts in the air. In this example, nodes N1 and N3 have sent bursts on the same resource. N2 is able to separate the bursts due to orthogonality, if N1 and N3 belong to different cells. N2 is not able to separate the bursts, however, if N1 and N3 belong to the same cell. In this situation, their bursts collide and the handshakes are broken.

When N2 detects the RTS bursts addressed to it, N2 measures interferences at 403. Node N2 estimates future interference by measuring the power level of received RTS messages. The measured power level value is compared to a criterion. At least two separate criterions are provided. The first criterion is maximum tolerable interference (MTI). When using the MTI as the criterion, if the sum of neighbor RTS bursts power levels stays under the MTI, then N2 is proceeds to step 404. The second criterion is minimum signal-to-interference-plus-noise-ratio (SINR). When using the SINR as the criterion, if the ratio of the node's own RTS burst power to the sum of neighbor RTS bursts power and noise power is above a minimum SINR, N2 proceeds to step 404.

The selection and application of the CTS acceptance policy and criterion limits are an important aspect of the invention. To ensure seamless operation, it is desirable to avoid situations when cells apply policies that contradict or disrupt each other. At least three alternatives are provided to coordinate the policy:
A central coordination entity (e.g. a support node, server, etc.) decides what policies will be applied and informs all participating APs about it. The APs are then obliged to follow the decision.
The APs choose the policy for themselves and inform the other participating APs about it via an AP-to-AP interface (e.g. X2) so that contradictions are avoided.
The policy is chosen in each AP independently according to measurements. For example, if an AP notices that there is a user who suffers from a lot of interference, it will choose to decrease MTI (increase minimum SINR) so that coverage is increased.

In one embodiment, whether the MTI or SINR criterion is chosen, the value of the threshold defines the size of the protected area around receivers, i.e. CTS transmitters. Lower MTI (or higher minimum SINR) leads to larger protection regions, which improves the coverage, but decreases maximum achievable system throughput. By tuning the thresholds, the system can apply the policy it prefers. If the criterion is not met (too much interference, too low SINR), there exists a possibility that the medium will be wasted, i.e. no network node transmits at a reserved bandwidth. Therefore, the receiver should be given a chance to also proceed in this case. This can be done in at least two ways:
The receiver can add information about the interference situation into the CTS burst and proceed to send the CTS at step 404. This information may say, for example, which transmitters have to stay silent so that the interference level stays tolerable; or
The receiver proceeds to send the CTS at step 404 with a probability Pr_{CTS}, which is a function of all received RTS bursts: Pr_{CTS}=f(RTS₁, RTS₂, . . . ). The concept is that if several users block each other from using the media, with a certain probability at least one of them is allowed to access it. The probability can be defined, for example, as:

$${Pr}_{CTS} = \frac{1}{{N}_{RTS}} ,$$

where N_{RTS} is the number of received RTS messages.

$${Pr}_{CTS} = \frac{1}{f ( {P}_{RTS} )} ,$$

where P_{RTS} is a sum of RTS receive powers, and f(.) is a function of the sum of first burst receive powers.
Or it can be a generic function of the RTS messages, their powers, and other relevant variables, of which the examples above are special cases. Other examples include a weighted average of the number of RTS messages, with the received powers as weights. Moreover, the definition of the function itself can be different for different situations.

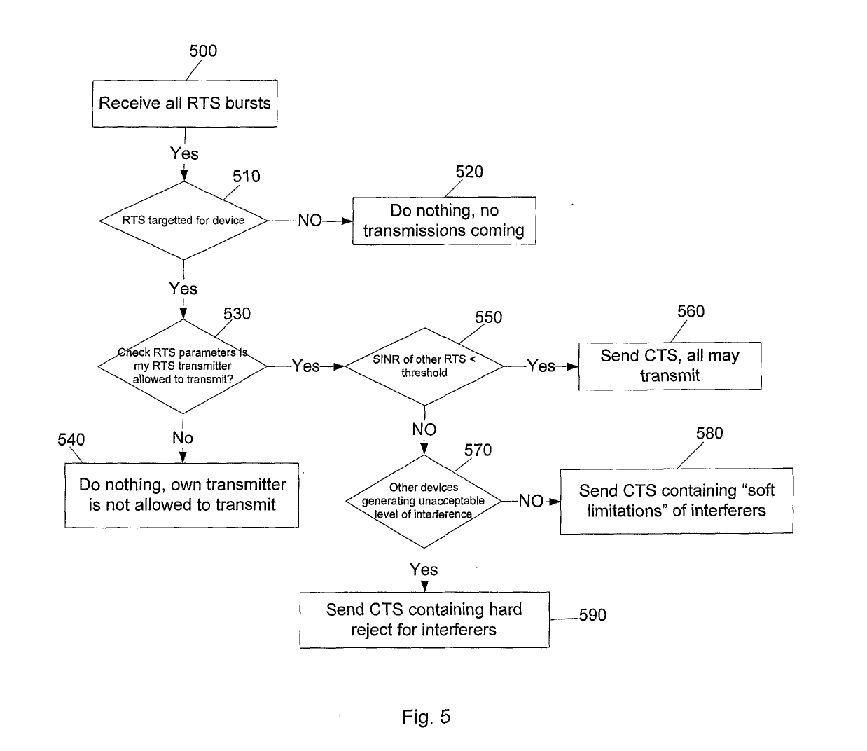

In another embodiment, all devices may transmit a RTS message, the AP may specify the devices that are allowed to transmit a RTS message, or the devices may use the same logic as defined in the previous embodiment discussed above. A second embodiment provides a decision flow for deciding the CTS message type and whether it should be transmitted and is illustrated in FIG. 5. At 500, the network node receives all RTS bursts. At 510, the network node decides whether any RTS is addressed to it. If the RTS is not addressed to the network node, then, at 520, the network node will not perform any transmission. If the RTS is indeed addressed to the network node, at 530, the network node checks from the channel access parameters whether it is allowed to send a CTS for the request. The channel access parameters for the RTS message may include: a waiting number, such as the number of reservation opportunities from the first time the RTS was issued; and/or a random number, such as between 0 and 255. The waiting number describes the amount of consecutive RTS transmission opportunities in which the device has transmitted the RTS message without successfully receiving a CTS response.

In certain embodiments, the network nodes may have limitations on the scale from which they may select the random number. For example, nodes who have not done reservations and have background traffic to transmit select the random number from 0 to 63. Devices who have not done reservations and have best effort traffic to transmit may select the random number from 64 to 127. The random numbers form 128 to 191 may be applied by the AP to DL transmissions or they may be allocated by the AP for devices that have requested permission to use these values. Values from 192 to 255 are reserved for future use, including support for emergency calls, etc.

With respect to allocating random numbers between 128 and 191, the terminal may request from the AP an allocation for certain time periods to use a random variable between 128 and 191. Typically, the request contains periodicity, the amount of consecutive reservations, and size of the reservation. The reservations may repeat with some periodicity. The knowledge of the periodicity sets the rules to schedule the RTS requests at time instances that do not collide. The nodes should detect the periodically repeating times that are free and allocate them for their transmissions.

The AP may set hard or soft medium use rules for media utilization. In soft medium use rules, the AP just keeps a record of the devices that are enabled to apply the high priority and limits the amount of the resource use. In hard medium use rules, the times when a device may use media and times when it shall not use the media may be specified. For instance, the traffic transmission periodicity may be split to slots which duration is the maximum reservation duration. The periodical RTS transmission policy rules are typically applied for VoIP and video streaming applications.

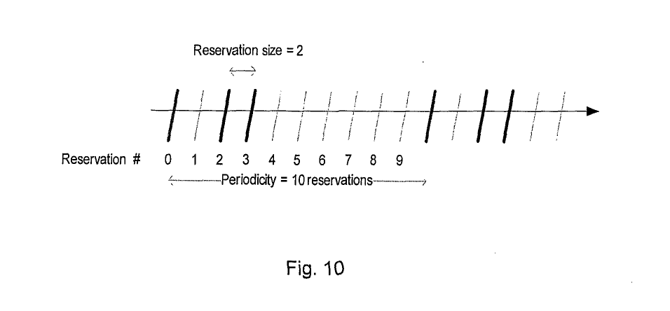

FIG. 10 illustrates an example of the hard medium use rules. According to this example, devices have reserved two UL & DL random access opportunities, #2 and #3, to be able to use high priority for their data exchange. Other reservation opportunities are not reserved.

The traffic periodicity, as shown in FIG. 10, is 10 random access opportunities.

According to certain embodiments, the node that receives a RTS message destined to it transmits the CTS message with the following principles:

If the random number is less than 128, the RTS message with the largest waiting number gets the CTS message. This is similar to a first come—first served principle.

If the random number is between 128 and 192, the RTS with largest random number gets the opportunity. If two or more RTS messages have the same number, the request with largest waiting number gets the CTS message. If two or more RTS messages that have the largest random number and waiting number are received, the destination of the RTS message is not entitled to send a CTS for any RTS message.

The Waiting Number describes the channel access delay and provides guidance of the congestion level of the medium.

If the network node is not allowed to transmit the CTS message, such as when the parameters in RTS frame does not allow the network node to transmit the CTS frame, then, at 540, the is network node does not transmit a CTS message. This limitation may be needed to decrease interference of the CTS messages.

At 550, when the network node is allowed to transmit the CTS message, the network node checks the level of restrictions it needs to set to the other nodes. In particular, the network node will compare the SINR of other RTS to the threshold. At 560, if the respective power levels of other nodes are below the level of the criterion, no transmission limitations are set to the other parallel transmitters in the CTS frame.

The system may have other more relaxed criterion for power levels. If the node detects that some node meets the more relaxed power level, the node may measure the needed reduction level of the transmission power and set a soft limitation in its CTS message for dedicated users at 580. The soft limitation provides commands to reduce the transmission power in order to meet the criterion for transmissions. The commanded node may select to reduce the transmission power or reject the transmission.

If the interference caused by a network node is clearly not within the criterion level, the CTS transmitter sends a CTS message that rejects all other transmissions, except the one that is destined to it and sends a CTS containing hard reject for interferers at 590. If a node receives contradicting CTS messages, i.e. some CTS messages allow the device to transmit and some do not, the device shall follow the guidance of the CTS message with the most acceptable random number and waiting number. The acceptance rules are the same as deciding on received RTS messages the device that is entitled to send the CTS message.

Returning to FIG. 4, at 404, corresponding to the CTS from FIG. 2, the node N2 sends CTS burst addressed to N1. At 405, node N1 is in receiving mode and listens to all CTS bursts that are present in the air. In this example, there are bursts from N2 and from N4. In the same manner as in step 402, N1 is able to separate the bursts if N2 and N4 are assigned to different cells. If N1 decodes RTS from N2, it proceeds to step 406 (or 407).

At 406, which is an optional step, N1 can estimate how much interference it would cause to the neighboring receiver nodes. By knowing the transmit power and measuring neighbor CTS bursts receive power, the future interference level caused by N1 transmissions can be estimated due to channel reciprocity. This information can then be used when deciding if the transmission should be initiated or not. In this case, the MTI criterion can be used.

At 407, node N1 performs conflict resolution. In one embodiment, node N1 considers all information obtained from the received CTS messages (including those from step 406, if available) and decides whether to start transmitting data or not. Some neighboring receivers may want node N1 to be silent completely, while others may have softer requirements (this would come in the additional CTS information, as described above). If there is no additional information and there remains a possibility of wasting the medium, node N1 can still use the same probability principle, Pr_{CTS}, as discussed above. This time the data would be placed with probability P_{data}=f(CTS₁, CTS₂, . . . ), and the multiple transmitters will block each other's transmissions and the probability to send data may be defined, for example, as:

$${Pr}_{data} = \frac{1}{{N}_{CTS}} ,$$

where N_{CTS} is the number of received CTS messages.

$${Pr}_{data} = \frac{1}{{P}_{CTS}} ,$$

where P_{CTS} is a sum of CTS receive powers

Depending on the decision outcome, N1 either proceeds to step 408, or does not continue with sending data.

In another embodiment, the receiver detects if any CTS message grants data transmission rights and possible limitations of transmission resource use and applies them to transmit data. Then, at 408, node N1 sends data to node N2.

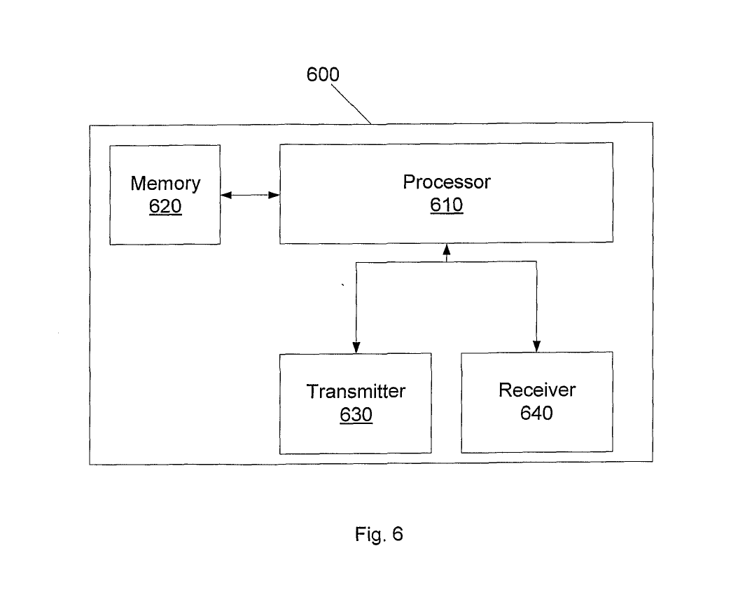

FIG. 6 illustrates a network node 600 according to an embodiment of the invention. According to one example, the network node 600 may be a wireless AP that allows communications devices to connect to the network. In other embodiments, the network node 600 may be a communications device or terminal, such as a user equipment, mobile station, computer, smart phone, personal data assistant, or any other communications or network device.

According to certain embodiments, network node 600 includes a processor 610, memory 620, transmitter 630, and receiver 640. Processor 610 may be configured to process information, execute instructions or operations, and control network node 600, or its components, to perform actions or operations such as transmitting, receiving, and/or analyzing data.

Processor 22 may be any type of general or specific purpose processor. Although only one processor is shown in FIG. 6, any number of processors may be included in network node 600 in accordance with other embodiments.

Network node 600 may further include memory 620 for storing information and instructions to be executed, for example, by processor 22. Memory 620 can be comprised of any combination of random access memory (“RAM”), read only memory (“ROM”), static storage such as a magnetic or optical disk, or any other type of machine or computer readable media. Although only one memory is shown in FIG. 6, multiple memory components may be included in network node 600 in accordance with other embodiments.

Computer readable media may be any available media that can be accessed by processor 610 and includes both volatile and nonvolatile media, removable and non-removable media, and communication media. Communication media may include computer program code or instructions, data structures, program modules or other data. The computer readable media may be at least partially embodied by a transmission line, a compact disk, digital-video disk, a magnetic tape, a Bernoulli drive, a magnetic disk, holographic disk or tape, flash memory, magnetoresistive memory, integrated circuits, or other digital processing apparatus memory device.

According to certain embodiments, memory 620 stores computer program code or instructions. The memory 620 including the computer program code can be configured, with the processor 610, to control network node 600 to perform actions. More specifically, in one embodiment, the memory 620 including the computer program code is configured, with the processor 610, to control network node 600 to select time/frequency resources to transmit data, to transmit RTS bursts to a second network node on the selected resources, and to enter a receiving mode to listen for all CTS bursts.

The network node 600 may be further controlled to receive, via receiver 640, CTS bursts, to separate any received CTS bursts by means of orthogonal codes when the CTS bursts are transmitted from different cells, to decode the CTS bursts that are received from the second network node, to estimate the level of interference the network node 600 would cause to neighboring receiver nodes, to determine whether to start transmitting data based on information in the received CTS bursts, and to transmit, via the transmitter 630, the data to the second network node when it is determined that data can be transmitted.

According to another embodiment, the memory 620 including the computer program code is configured, with the processor 610, to control network node 600 to listen for all RTS bursts, to separate the received RTS bursts based on orthogonality when the RTS bursts are transmitted from different cells, to estimate future interference by measuring a power level of the received RTS bursts and comparing the measured power level to a criterion, such as MTI or SINR, as discussed above. When the criterion is met, the network node 600 may be controlled to send, via transmitter 630, a CTS burst to another network node. When the criterion is not met, the network node 600 may be controlled to determine whether the sending of a CTS is allowed. If the sending of a CTS is not allowed, no transmission of a CTS will be made. If it is allowed, the network node 600 is controlled to determine the level of restrictions that should be set for transmissions from other nodes, and to send a CTS containing the determined level of restrictions. The level of restrictions may include soft limitations, hard limitations, no limitations, or a complete restriction on transmissions.

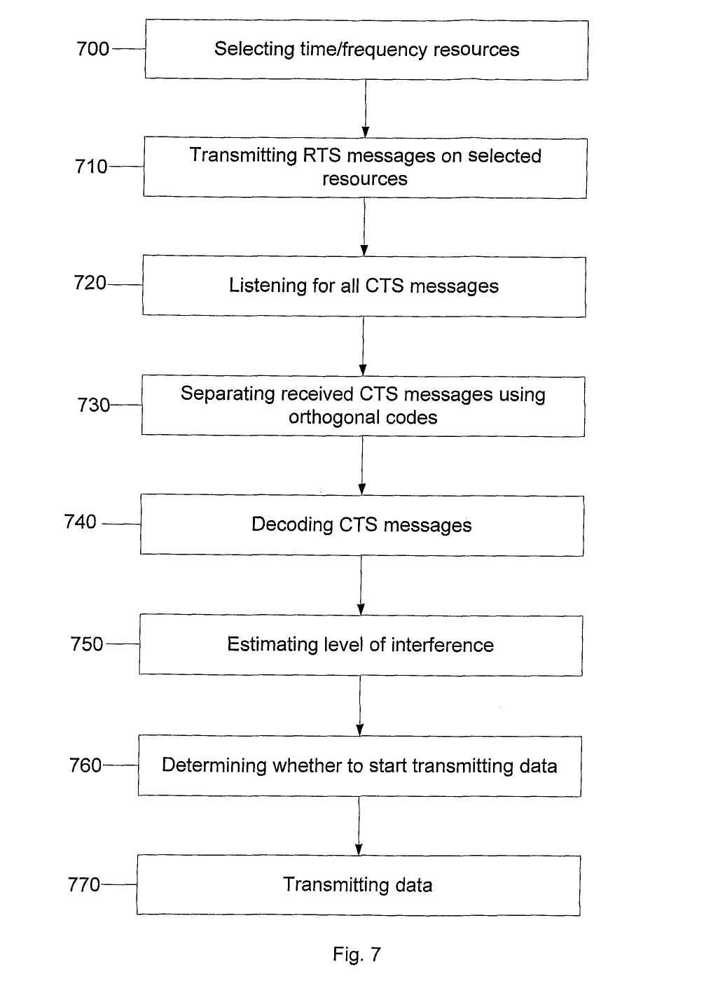

FIG. 7 illustrates a flow chart of a method for reducing interference according to one embodiment. In one example, the method may be performed by network node N1 shown in FIG. 4. The method includes, as illustrated in FIG. 7, at 700, selecting time/frequency resources to transmit data on. At 710, the method includes transmitting RTS bursts to a second network node on the selected time/frequency resources, and, at 720, entering receiving mode and listening for all CTS bursts. At 730, the method continues by separating received CTS bursts that were encoded with orthogonal codes when the received CTS bursts were transmitted from different cells. At 740, the method includes decoding CTS bursts that are received from the second network node and, at 750, the method may optionally include estimating the level of interference the network node would cause to neighboring receiver nodes. At 760, the method includes determining whether to start transmitting data, and, at 770, transmitting the data to the second network node when it is determined that data can be transmitted. The determination of whether data can be transmitted may be made based on information contained in the received CTS bursts. In an embodiment, the RTS bursts and/or the CTS bursts are encoded with orthogonal codes when there are multiple cells in a neighborhood of the first network node and/or the second network node

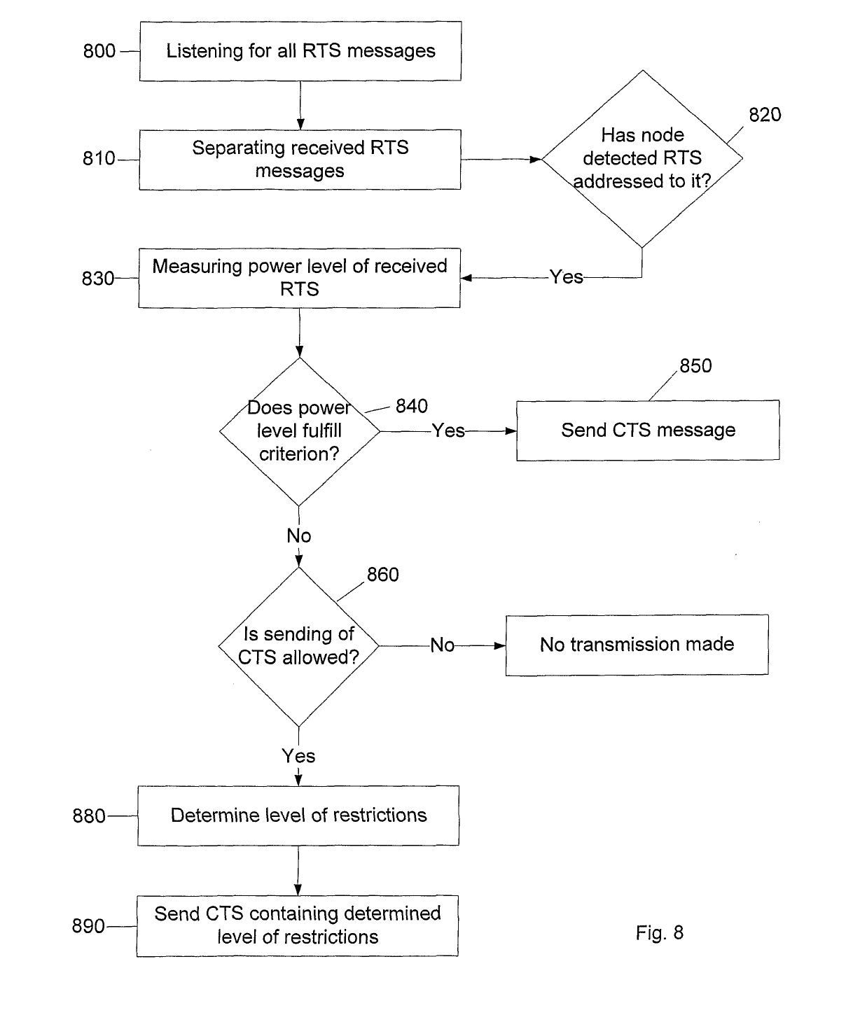

FIG. 8 illustrates a flow chart of a method for reducing interference according to one embodiment. In one example, the method may be performed by network node N2 shown in FIG. 4. As illustrated in FIG. 8, the method includes, at 800, listening for all RTS bursts. At is 810, the method includes separating the received RTS bursts that were encoded using orthogonal codes when the RTS bursts were transmitted from different cells. At 820, it is determined whether the node has received at least one RTS burst addressed to it and, if so, the method includes, at 830, measuring a power level of the received RTS bursts. At 840, a determination is made as to whether the measured power level fulfills a criterion, such as MTI and SINR discussed above. If the power level does fulfill the criterion, then the method includes sending a CTS burst at 850. If the power level does not fulfill the criterion, the method includes determining, at 860, whether the sending of CTS bursts is allowed. If it is not allowed, then no transmission is made 870. If it is allowed, then the method includes, at 880, determining the level of restrictions that should be set on the transmissions of other nodes and, at 890, sending a CTS burst containing the determined level of restrictions. As mentioned above, the level of restrictions may include soft limitations, hard limitations, no limitations, or an allowance of only a single transmission.

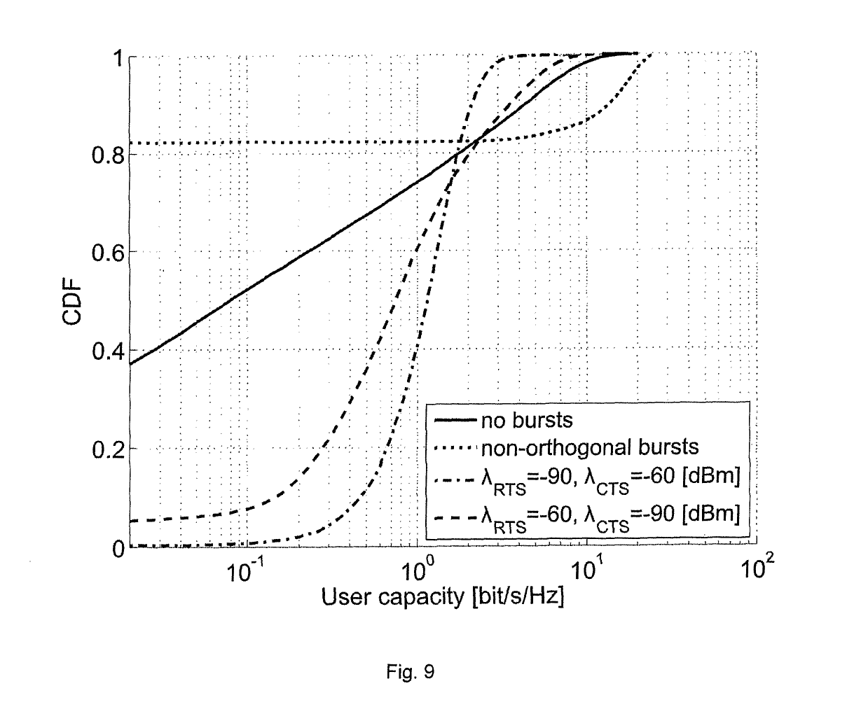

FIG. 9 illustrates simulated performance of single-band system with no bursts, non-orthogonal bursts, and ideally orthogonal bursts with two different MTI threshold settings. It assumes a single-band system (as in FIG. 2) in an indoor scenario and compares cumulative distribution functions of normalized user capacity of a system with no bursts, a system with bursts that are not orthogonal, and a system with ideally orthogonal bursts with two different MTI threshold settings (λ_{RTS} and λ_{CTS}). For the system with no bursts, more than 35% of the nodes are in outage. For the system with non-orthogonal bursts a few users are in a better situation as compared to the system without bursts, but more than 80% of nodes are in outage. For the system described herein with orthogonal RTS and CTS bursts, outage is significantly reduced if not eliminated. By tuning the MTI thresholds, it can tune the trade-off between high throughput and user fairness.

Some resulting advantages include, but are not limited to, the fact that RTS/CTS handshaking offers a possibility of deploying decentralized MAC. Additionally, orthogonal RTS and CTS bursts can be used to predict interference and thus define a protected area around active receivers. This can be crucial for achieving user fairness (throughput for nodes at cell edge or other bad positions). Also, the bursts fit into the OFDMA frame structure, so that the system is backward compatible with 3GPP Release 8 and later releases.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1.-35. (canceled)

36. A method, comprising:
selecting, by a first network node, time/frequency resources to transmit data;
transmitting first bursts to a second network node on the selected resources;
listening for second bursts;
separating received second bursts;
decoding the second bursts received from the second network node;
determining whether data is allowed to be transmitted based on the received second bursts; and
transmitting the data to the second network node when it is determined that the data can be transmitted,
wherein at least one of the first bursts and the second bursts are encoded with orthogonal codes when there are multiple cells in a neighborhood of the first network node and/or the second network node.

37. The method according to claim 36, wherein the first bursts comprise request to send (RTS) bursts, and the second bursts comprise clear to send (CTS) bursts.

38. The method according to claim 36, further comprising estimating level of interference the first network node would cause to neighboring receiver nodes.

39. The method according to claim 36, wherein the determining comprises detecting whether any of the second bursts comprises at least one of: grant data transmission rights, include possible restrictions on transmission resource use, and applying at least one of the detected data transmission right, restrictions to transmit the data.

40. An apparatus, comprising:
at least one processor; and
at least one memory including computer program code;
the at least one memory and the computer program code configured, with the at least one processor, to cause the apparatus at least to
select time/frequency resources to transmit data;
transmit first bursts to a network node on the selected resources;
listen for second bursts;
separate received second bursts;
decode the second bursts received from the network node;
determine whether data is allowed to be transmitted based on the received second bursts; and
transmit the data to the network node when it is determined that the data can be transmitted,
wherein at least one of the first bursts and the second bursts are encoded with orthogonal codes when there are multiple cells in a neighborhood of the first network node and/or the second network node.

41. The apparatus according to claim 40, wherein the first bursts comprise request to send (RTS) bursts, and the second bursts comprise clear to send (CTS) bursts.

42. The apparatus according to claim 40, wherein the at least one memory and the computer program code are further configured, with the at least one processor, to cause the apparatus to estimate a level of interference the apparatus would cause to neighboring receiver nodes.

43. The apparatus according to claim 40, wherein the at least one memory and the computer program code are configured, with the at least one processor, to cause the apparatus to detect whether any of the second bursts comprises at least one of: grant data transmission rights, include possible restrictions on transmission resource use, and apply at least one of the detected data transmission right, restrictions to transmit the data.

44. A computer program, embodied on a computer readable medium, the computer program configured to control a processor to perform operations, comprising:
selecting, by a first network node, time/frequency resources to transmit data;
transmitting first bursts to a second network node on the selected resources;
listening for second bursts;
separating received second bursts;
decoding the second bursts received from the second network node;
determining whether data is allowed to be transmitted based on the received second bursts; and
transmitting the data to the second network node when it is determined that the data can be transmitted,
wherein the second bursts are encoded with orthogonal codes when there are multiple cells in a neighborhood of the first network node and/or the second network node.

45. A method, comprising:
listening for first bursts;
separating received first bursts that are encoded using orthogonal codes when the first bursts are transmitted from different cells;
estimating future interference by measuring a power level of the received first bursts and comparing the measured power level to at least one criterion; and
when the at least one criterion is met, sending a second burst to a first network node.

46. The method according to claim 45, wherein the comparing comprises comparing at least one of: the measured power level to a maximum tolerable interference (MTI), the measured power level to a signal-to-interference-plus-noise-ratio (SINR).

47. The method according to claim 45, further comprising at least one of: when the criterion is not met, adding information about interference situation to the second burst and sending the second burst to the first network node; when the criterion is not met, calculating a function of all received first bursts as a probability to allow at least one node to transmit.

48. The method according to claim 47, wherein the information about the interference situation comprises information about which transmitters must stay silent so that interference level is acceptable.

49. The method according to claim 45, wherein, when the criterion is not met, the method further comprises:
checking, from random variables included in the first bursts, whether sending of the second burst in response to the first bursts is allowed; and
when the sending of the second burst is allowed, checking level of restrictions that should be set for other nodes;
wherein, when other nodes are below the criterion, no restrictions are made on other transmissions, and
wherein, when the criterion is almost met, soft limitations are set.

50. An apparatus, comprising:
at least one processor; and
at least one memory including computer program code;
the at least one memory and the computer program code configured, with the at least one processor, to cause the apparatus at least to
listen for first bursts;
separate received first bursts that are encoded using orthogonal codes when the first bursts are transmitted from different cells;
estimate future interference by measuring a power level of the received first bursts and comparing the measured power level to at least one criterion; and
when the at least one criterion is met, send a second burst to a first network node.

51. The apparatus according to claim 50, wherein the at least one memory and the computer program code are further configured, with the at least one processor, to cause the apparatus to compare at least one of: the measured power level to a maximum tolerable interference (MTI), the measured power level to a signal-to-interference-plus-noise-ratio (SINR).

52. The apparatus according to claim 50, wherein, when the criterion is not met, the at least one memory and the computer program code are further configured, with the at least one processor, to cause the apparatus to perform at least one of: to add information about interference situation to the second burst and send the second burst to the first network node; to calculate a function of all received first bursts as a probability to allow at least one node to transmit.

53. The apparatus according to claim 52, wherein the information about the interference situation comprises information about which transmitters must stay silent so that interference level is acceptable.

54. The apparatus according to claim 50, wherein, when the criterion is not met, the at least one memory and the computer program code are further configured, with the at least one processor, to cause the apparatus to
check, from random variables included in the first bursts, whether sending of a second burst in response to the first bursts is allowed; and
when the sending of the second burst is allowed, check level of restrictions that should be set for other nodes;
wherein, when other nodes are below the criterion, no restrictions are made on other transmissions, and
wherein, when the criterion is almost met, soft limitations are set.

55. A computer program, embodied on a computer readable medium, the computer program configured to control a processor to perform operations, comprising:
listening for first bursts;
separating received first bursts that are encoded using orthogonal codes when the first bursts are transmitted from different cells;
estimating future interference by measuring a power level of the received first bursts and comparing the measured power level to at least one criterion; and
when the at least one criterion is met, sending a second burst to a first network node.
